(19) United States
(12) Patent Application Publication
(10) Pub. No.: US 2008/0053353 A1
(43) Pub. Date: Mar. 6, 2008

(54) Four box seed box mount with rotary platform and unloading conveyor

(76) Inventors: Norbert Werner, Dodge City, KS (US); Thomas A. Klenke, Spearville, KS (US); Denny Schawe, Spearville, KS (US)

Correspondence Address: Wm. Bruce Day;DAY LAW FIRM, P.C., Suite 300, 4330 Belleview, Kansas City, MO, 64111-3579, US

(21) Appl. No.: 11/513,585

(22) Filed: Sep. 1, 2006

(51) Int. Cl. A01C 15/00

(52) U.S. Cl. 111/200

(57) ABSTRACT

A seed box mount is designed to contain four seed boxes yet provide easy access for side loading and unloading of the boxes. The mount can be a trailer, a truck body or a fixed frame. The mount includes an integral seed unloading conveyor which swings from a sidewardly extending unloading position to a stowed position swung forwardly for road transport when used in a trailer embodiment. A rotary platform has receptacle stations for holding each of the four seed boxes and an outlet in each receptacle aligned with the bottom outlet gate of the seed box. Dump chutes including self tending flexible cuffs extend below each of the receptacle stations. The platform rotates under power to selectively position a seed box aligned with the feed end of the conveyor for refilling seed bins of planters, drills and other seeder implements. The seed box mount provides low height, multiple box carrying capacity and because of the design of the dump chute and flexible cuffs, prevents seed spillage.

### FIELD OF THE INVENTION

This invention relates to agricultural seed handling machinery and particularly to systems designed for handling reusable seed boxes.

### BACKGROUND OF THE INVENTION

Within the last few years, a preferred method for supplying hybrid seed to the farm has been through the use of the seed box. These are plastic, typically are 58 cubic feet and are 56″L, 45″W and 65″H. When full, the seed box typically weighs 2800 lbs. A significant industry supplier of seed boxes is Buckhorn, Incorporated, at www.buckhorninc.com. Full seed boxes are delivered by the seed grower to the local supplier and then delivered to the farmer. They are collapsible and when empty, are returned up the chain of distribution for reuse. The seed boxes protect expensive hybrid seed from damage and are a preferred form of supply for the large scale planter. A difficulty with use has been in emptying the seed from the boxes into planter implement seed containers. Devices have developed for transferring the seed from the seed box to a large bin that is hauled into the field and from the bin into the planter seed containers. However, because increased handling causes loss and fracturing, systems have been developed for mounting the seed box directly on a field transportable truck or trailer equipped with an unloading conveyor. This system can be driven to the planter in use in the field and seed unloaded from the seed boxes directly into the seed bins mounted on the planter.

Because large scale users require large amounts of bulk seed, the goal has been to carry as many bulk seed containers as possible on a trailer equipped with an unloading conveyor. Of the various commercial manufacturers of bulk seed handling systems, Crustbuster/Speed King, Inc., Friesen of Iowa, Inc. and Sudenga Industries, Inc. are known to provide multi seed box handling equipment. Sudenga (U.S. Pat. No. 5,257,893) makes two and three box units. In the two box unit, the boxes must be on a platform that is raised high enough to provide flow from out of the box bottom unloading gate into a funnel shaped hopper, then from the hopper through a tubular conveyor. The Sudenga three box unit requires both height and a separate bottom conveyor leading to a discharge conveyor. The Friesen units, the two box and four box Seed Titan units, are high above the ground surface to allow sufficient angle for the discharge hoppers mounted under the bin platform. This height is a disadvantage when cornering or towing the carrier over farm roads. Inadvertently dropping a wheel into a roadside ditch while turning or crossing a terrace could cause the entire unit to roll over. Because of the problems of inherent instability caused by the height and difficulties with loading and unloading the seed box carrier, new designs are needed.

### BRIEF DESCRIPTION OF THE DRAWINGS

FIG. 1 is a perspective view of a preferred embodiment of the four box seed box trailer with rotary platform and unloading conveyor showing seed boxes in place.

FIG. 2 is a perspective of the four box seed box trailer with rotary platform and unloading conveyor without seed boxes.

FIG. 3 is a disassembled perspective view, without the seed unloading.

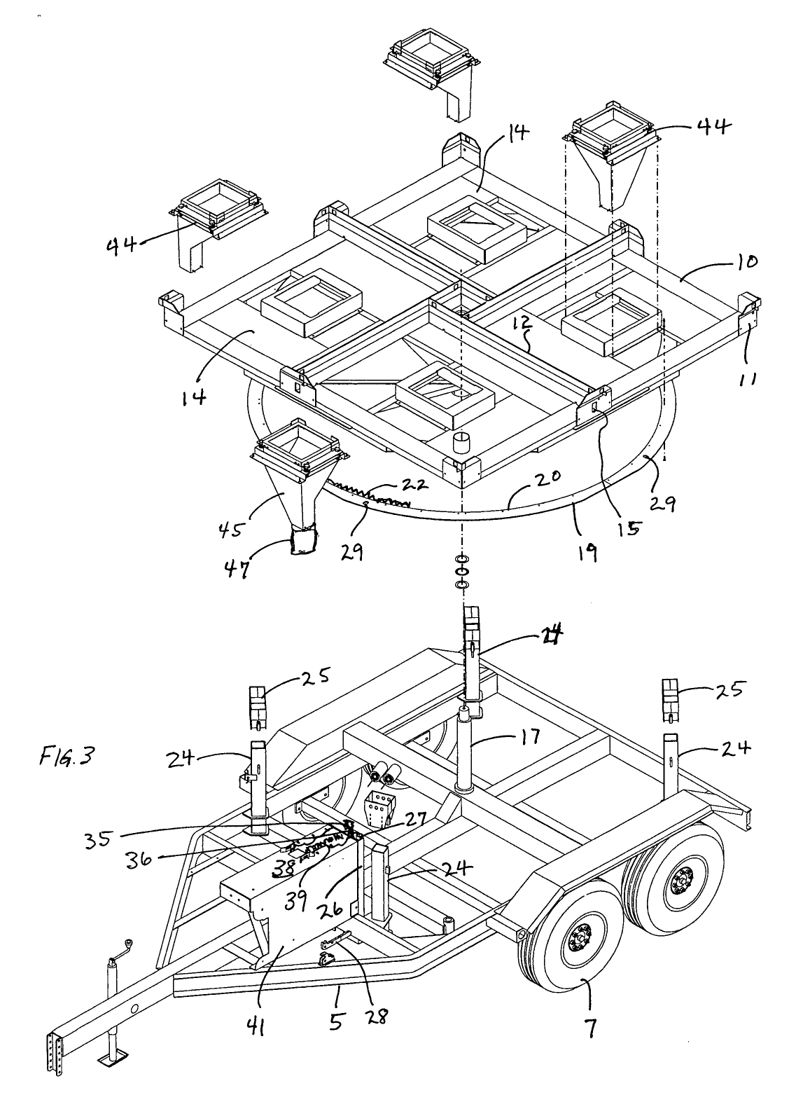

FIG. 4 is a disassembled, perspective view of a drive mechanism for rotating the seed box holding platform.

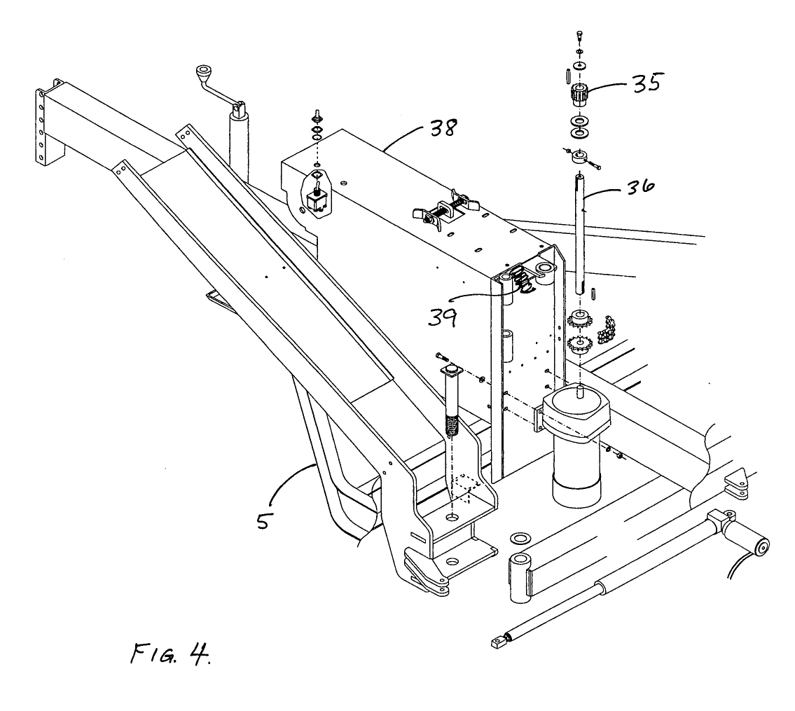

### SUMMARY OF THE INVENTION

The invention is an agricultural seed box carrier or mount that is configured to carry four seed boxes, although its unique principle of operation may allow the design to be adapted to 3, 5 or more seed boxes. The carrier accommodates up to four standard seed boxes and secures them to a rotary platform so that the boxes do not tip over or fall off during transport. Each box receiving station on the platform has a short length chute which mates with the seed box bottom gate so that when the box gate is opened, seed flows from the box and through the station dump chute. The platform rotates on a base frame and positions the dump chute leading from each seed box above the inlet of a discharge conveyor. A flexible cuff is attached to the outlet of each dump chute and directs the seed into the conveyor inlet. The cuff provides a self tending feature preventing spillage of seed and self regulates flow into the conveyor inlet. The discharge conveyor is preferably mounted at a front corner of the mount structure and is sidewardly swingable to fill planter implement seed receptacles or other smaller containers as desired. The discharge conveyor stows longitudinally against the side of the frame. The rotary platform concept also permits ease of loading of the mount; a forklift can move back and forth from a seed box supply to the mount and the platform rotated so that the position to be filled is always easily accessible to the forklift operator. The mount can be trailer mounted, truck mounted, or a stationary mount. The rotatable platform with short length dump chute provides a low height seed box mount.

### OBJECTS OF THE INVENTION

The objects of the invention are:

To provide a seed box carrier or mount that can carry multiple seed boxes;

To provide a seed box carrier that is compact and short in height so as not to be top heavy so it can be used in the field;

To provide a seed box carrier in which seed boxes can be easily loaded and unloaded;

To provide a seed box carrier which easily unloads seed from the boxes into planter implement seed receptacles; and

To provide a seed box carrier which is well suited for the intended purpose, efficient and durable. Other objects and advantages of the invention may become apparent from the following specification.

### DESCRIPTION OF THE PREFERRED AND ALTERNATE EMBODIMENTS

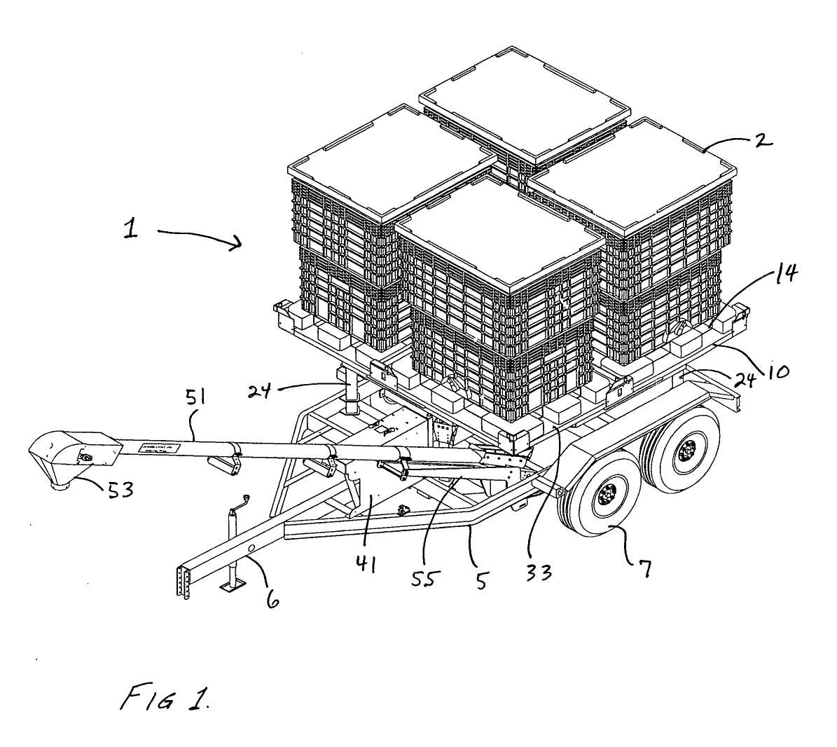

The reference number 1, FIG. 1 generally indicates a seed box mount. In the illustrated example, the mount is a trailer, although the mount can also be on a truck body or even a stationary mount. Seed box trailer 11 is designed to carry seed boxes 2, of which four are shown on the seed box trailer 1. Seed boxes 2 are of molded plastic construction and are provided by commercial seed growers filled with costly hybrid seed to local farm elevators and seed dealers. The farm operator will obtain seed from the local dealer in these seed boxes 2 and transport a plurality of the boxes by truck to farm whereupon they are removed from the truck using a forklift and set down upon a mount, such as the seed box trailer 1, which is then able to transport the seed boxes 2 to a location on the farm where planting operations occur. Presently, two sizes of seed boxes are used, one holds 58 cubic feet and is 56 inches long, 45 inches wide and 65 inches high and is available from Buckhorn, Incorporated. The invention is designed to fit all available seed boxes. When full the seed box typically weighs 2,800 pounds. Each seed box 2 is collapsible to roughly half its height so that after use it can be shipped back to the seed producer. The seed boxes include a top which is secured to the container and a bottom opening secured by a slidable gate device. To open the box to let seed run out, the gate is opened.

The seed box trailer 1 generally consists of a rectangular frame 5 with a draw tongue 6 and ground engaging wheels 7. When the mount is not a trailer, any type of suitable and sturdy framework may be used. The trailer frame 5 is towable behind a tractor or other prime mover. A rotary platform 10 is mounted on the trailer frame 5 and is generally square shaped. A plurality of corner walls 11 and divider walls 12 partition the rotary platform 10 into stations 14 for each of the seed boxes 2. As shown in FIG. 1, the seed box is rectangularly shaped so that to fully cover the square area of the rotary platform 10, the seed boxes are oriented so that the longitudinal axis of two of them are transverse to the platform 10 and the other two are longitudinal to the platform 10, as shown in the momentary rotary orientation of FIG. 1. Each seed box 2 is configured so that it may be lifted by a forklift truck from either its long dimension or short dimension. Each of the receiving stations 14 on the platform 10 is similarly configured so that unimpeded access to the fork channels of a seed box 2 in each of the receiving positions 14 is available. Lock rods (not shown) fit through openings 15 to hold the box 2 secure when the box is loaded into the receiving station 14.

The rotary platform 10 is mounted upon the trailer frame 5 or other suitable mount structure by a sturdy pin and bushing connection 17. The pin and bushing connector 17 is a center pivot and is also centrally placed on the trailer frame 5. A wear ring 19 is mounted to the underside of the rotary platform 10 adjacent the platform periphery and has an inner wall 20 to which a ring gear 22 is mounted. To support the rotary platform 10 against wobbling on the center pivot 17, a series of peripheral support posts 24, such as four in number, are placed around the trailer frame 5 and extend upwardly to contact wear ring 19. Caps with rollers 25 mount atop each support post 24 and bear against the wear ring 19 to support the periphery of the rotary platform 10 against wobbling on its center pivot 17. A stop mechanism 26 consisting of a post has a retractable pin 27 which provides an indexing function to the rotary platform 10 with respect to the trailer frame 5. Ring gear 22 has indexing holes 29 situated so as to place each of the platform seed box receiving positions 14 at a dumping station, as hereafter described. The retractable pin 27 is spring loaded to an upwardly extended position and automatically snaps into the indexing holes 29 as they come into registration with pin 27. The pin 27 is retractable by various means and may be electrically operated or by mechanical lever 28.

In the illustrated example, the seed box trailer 1 has unloading station 33 located at its forward left position. The rotary platform 10 is caused to rotate to place each of the seed boxes 2 at the unloading station 33 by a powered pinion gear 35 mounted to a shaft 36 that is caused to rotate by hydraulic power applied from the tractor. The pinion gear 35 is in meshed contact with the ring gear 22 so that as the gear 35 rotates, the rotary platform 10 rotates. To alleviate jolting as the pinion gear 35 starts and stops, the shaft 36 is mounted to a spring dampener assembly 38 consisting of an elongate coil spring 39 covered within a housing 41. The shaft 36 is free to rock back and forth upon starting and stopping so that the pinion gear 35 slides slightly outwardly on the teeth to take up slack and reduce jolting. The operator has a remote control device (not shown) that causes the pinion gear 35 to start and stop while the operator holds the lever 28 down so that the retractable pin 27 retracts and allows the rotary platform 10 to revolve and index to the unloading station 33.

Each seed box receiving station 14 includes a sealed outlet assembly 44, such as shown in our U.S. Pat. No. 6,505,760 aligned under the center of each seed box 2. The outlet assembly 44 is generally funnel shaped with converging walls 45 and with a flexible cuff 47, such as a fabric material, sealed to the outlet of the converging walls 45 and extending a short distance below the termination of the walls 45. The outlet assembly forms a dump chute which receives the seed from the seed box when the seed box gate is opened. The dump chute is short in length, allowing the rotary platform 10 to be close to its supporting framework.

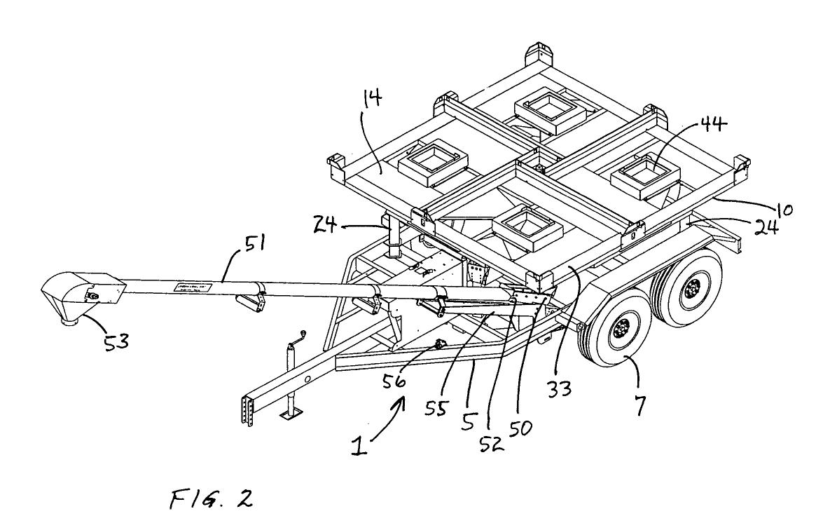

Underneath the unloading station 33 is a receiving opening 50 FIG. 2, for a discharge conveyor 51. The discharge conveyor 51 funnel shaped opening 50 leads into the feed end 52 of the conveyor 51. Preferably the conveyor 51 is a powered belt (not shown) which runs within an outer tube and dumps into a discharge head 53 for unloading the seed into planter implement seed containers. The discharge conveyor 51 maybe manually swingable through 120 degrees of movement, as provided in the illustrated example, or may include a powered swing carriage 55 actuated by hydraulics from the towing tractor or other hydraulic pump. The discharge conveyor 51 can swing forwardly and sidewardly throughout a significant range of travel so as to reach the planter implement seed containers. For over the road travel, the discharge conveyor 51 swings longitudinally forwardly to nest parallel to the trailer frame 5 and in a stowed position.

When the dump chute outlet assembly 44 is indexed over the conveyor opening 50 at the unloading station 50, the flexible cuff 47 is sufficiently long to extend into the opening 50 and terminate only a short distance above the opening floor. When the conveyor 51 is running, seed flows smoothly through the dump chute and cuff, but when the conveyor is stopped, seed will back up in the cuff and stop flow. Flow starts automatically again when the conveyor is running. This feature makes the dump chute self tending and reduces or eliminates spillage.

The discharge conveyor 51 may be tilted downwardly to attach to the trailer frame 5 at a latch 56 in a secured forwardly extending position stowed for road travel.

The above specification is for illustrative purposes only and the invention may be utilized in various forms and embodiments within the scope of the invention. The invention is not limited to a specific embodiment except insofar as set forth in the claims.

What is claimed and desired to be secured by Letters Patent is:

1. A seed box mount arrangement, comprising:
a) a base frame;
b) a rotary platform mounted on said base frame;
c) seed box receiving stations arrayed on said platform and having outlets mating with outlets in the seed boxes;
d) a dump chute extending between said base frame and said platform; and
e) an unloading conveyor connected to said base frame and having an inlet end receiving seed from the seed boxes through said dump chute and including a conveyor discharge end for discharging seed.

2. The seed box mount arrangement set forth in claim 1 wherein:
a) said rotary platform has four said seed bin stations; and
b) said rotary platform is mounted to said base frame by a center pivot.

3. The seed box mount arrangement set forth in claim 2 including a power unit causing said rotary platform to rotate about said center pivot and place selected seed boxes at a dumping station aligned with said unloading conveyor.

4. The seed box mount arrangement set forth in claim 3 wherein said power unit includes ring and pinion gears.

5. The seed box mount arrangement set forth in claim 2 including a stop positioning the rotary platform so that said outlets of the seed bin stations are selectively in registration with the unloading conveyor.

6. The seed box mount arrangement set forth in claim 2 wherein said unloading conveyor is mounted to a front corner of said base frame and stows forwardly along said base frame.

7. The seed box mount arrangement set forth in claim 2 wherein said conveyor has a belt running inside a conveying tube.

8. A seed box carriage arrangement comprising;
a) a base frame having wheels for movement;
b) a platform mounted upon said base frame and connected thereto by a center pivot for rotation, the platform being generally square and having four seed box stations for situating seed boxes thereon, the platform having respective flow through outlets in each of said stations in communication with outlets of said seed boxes;
c) a power rotational arrangement extending between said base frame and said platform and operable to cause said platform to rotate to place said stations at a selected unloading position with respect to said base frame;
d) dump chutes extending downwardly from each of the seed box stations and terminating in flexible cuffs; and
e) an unloading conveyor connected to said base frame and having a lower feed end hopper positioned under one of said dump chutes, and also having an upper discharge end, the flexible cuff extending into the conveyor feed end hopper and controlling flow of seed, the conveyor swing mounted to the frame and movable between a sidewardly extended use position and a stowed in trail position for transport of the seed box carriage arrangement.
